(19) United States
(12) Patent Application Publication
(10) Pub. No.: US 2019/0277682 A1
(43) Pub. Date: Sep. 12, 2019

(54) CORIOLIS MASS FLOW METER AND DENSIMETER WITH LITTLE PRESSURE DEPENDENCE, AND METHOD FOR MANUFACTURING THE SAME

(71) Applicant: ROTA YOKOGAWA GMBH & CO. KG, Wehr (DE)

(72) Inventor: Martin RICKEN, Bad Saeckingen (DE)

(21) Appl. No.: 15/926,124

(22) Filed: Mar. 20, 2018

(30) Foreign Application Priority Data
Mar. 6, 2018 (DE) 10 2018 001 778.9

(51) Int. Cl. G01F 1/84

(52) U.S. Cl. CPC G01F 1/8413; G01F 1/8427; G01F 1/8422

(57) ABSTRACT

The invention relates to a Coriolis mass flow meter, comprising a housing with an inlet and an outlet for a fluid medium, which are arranged along a flow axis (d), at least one measuring tube configured to allow the fluid medium to flow through it in a flow direction (x) and arranged between the inlet and the outlet, wherein the measuring tube includes at least one section with an oval cross-section, so that the measuring tube in this section comprises, perpendicular to the flow direction (x), a longer axis (a) and a shorter axis (b), a vibration exciter (D) configured to cause the measuring tube to vibrate in a vibration direction (f), and two vibration sensors for detection of the movements of the measuring tube, wherein the longer axis (a) of the oval cross-section of the measuring tube is oriented essentially in the vibration direction (f). Moreover, the invention relates to a method for manufacturing a Coriolis mass flow meter with little pressure dependence.

### FIELD

The invention relates to a Coriolis mass flow meter with little pressure dependence and to a method for manufacturing such a Coriolis mass flow meter.

### BACKGROUND

Generic Coriolis mass flow meters are known, for example, from EP 2 657 659 A1 or DE 10 2012 016 490 A1. They are employed in various industries to measure the mass flow and/or the density of the fluid. Known Coriolis mass flow meters comprise a housing with an inlet and an outlet for a substance to be measured, i.e. a fluid medium, said inlet and outlet being arranged along a flow axis. The flow axis corresponds, for example, to the flow direction in a straight tube section in which the Coriolis mass flow meter is interposed. Moreover, the Coriolis mass flow meter comprises at least one measuring tube which is configured to allow a substance to be measured to flow through it in a flow direction and which is arranged between the inlet and the outlet. The measuring tube can lead the substance to be measured from the inlet to the outlet via various paths, for example, the measuring tube can be arcuate, U-shaped or straight. In such configurations, the flow direction of the substance to be measured can deviate from the flow axis by up to 90°. The measuring tube itself is adapted to the specific application, for example, with a large diameter for large flow volumes. This way, the Coriolis mass flow meter is adapted to the fluid to be measured and the expected volumetric flow rates.

The measurement itself is then based on the Coriolis principle. For this purpose, the Coriolis mass flow meter comprises a vibration exciter configured to cause vibrations, preferably resonant vibrations, in the measuring tube in a vibration direction. The exciter can be configured, for example, as an electromagnetic driving coil. Moreover, two vibration sensors are provided for detection of the movements of the measuring tube and are, for example, arranged on the measuring tube so as to be spaced apart from each other along the flow direction of the measuring tube preferably on different sides of the vibration exciter. Due to the vibration of the measuring tubes induced by the exciter, Coriolis forces act on the fluid flowing inside the measuring tube and lead to a phase shift of the vibration detected by the vibration sensors. The mass flow of the fluid flowing through the measuring tube can be inferred from this phase shift. The density of the substance to be measured can be derived from the frequency of the resonant vibrations of the measuring tube. Coriolis mass flow meters are characterized by high precision and particularly flexible range of applications, which is why they are widely used and employed for measuring a large variety of fluids.

As explained above, the mass flow and the density of the fluid medium are determined on the basis of the measured vibrations of the measuring tube. Changes in vibration characteristics, for example the stiffness of the measuring tube, can result in interfering influences, in particular during operation. For the stiffness of the measuring tubes increases with increasing internal pressure, i.e. the increasing pressure of the fluid to be measured. Accordingly, the values measured by the Coriolis mass flow meter change with the pressure of the fluid to be measured. It is already known to calculate this pressure dependence, to measure the pressure of the fluid and to take into account and mathematically compensate the influence of the pressure on the measured values when evaluating the measurement. This is, however, disadvantageous in that, for one thing, the pressure needs to be determined separately and the evaluation of the measurement results is made more complicated. This increases the cost of the measuring site, and the involvement and installation of a pressure gauge leads to increased maintenance needs and an increased number of potential sources of error.

### SUMMARY

The object of the present invention is thus to reduce the pressure dependence of the measurement of the mass flow of the fluid and/or of the fluid density to be measured in a Coriolis mass flow meter. This is to be realized in such a manner that no additional measurements, e.g. pressure measurements, are required. An aim is thus to reduce the overall cost of the installation of the measurement site and associated maintenance needs.

Specifically, the object is achieved with a Coriolis mass flow meter as mentioned above, in which the measuring tube has at least one section with an oval cross-section so that the measuring tube, i.e. the cross-section of the measuring tube, comprises a longer axis and a shorter axis in this section perpendicular to the flow direction, the longer axis of the oval cross-section of the measuring tube being oriented essentially in the vibration direction. Compared to a tube with a circular cross-section, a tube section with an oval cross-section has an increased stiffness with respect to bending in the direction of the longer axis of the oval cross-section. The invention is based on the insight that an increase of the internal pressure in a tube with an oval cross-section will reduce the ovality of the cross-section (which is defined here as the ratio of the longer axis to the shorter axis), i.e. the longer axis becomes shorter and the shorter axis of the cross-section becomes longer. This effect will hereinafter also be referred to as rounding since the oval tube approximates the shape of a tube with a circular cross-section. Due to the rounding of the measuring tube, the stiffness with respect to a bending in the direction of the longer axis of the oval cross-section decreases with increasing internal pressure. However, as already mentioned above, the stiffness of a measuring tube generally increases with increasing internal pressure. This effect also occurs in oval tubes. The core idea of the present invention is thus to balance the increase in stiffness in the case of an increasing internal pressure and the decrease in stiffness in the direction of the longer axis caused by the rounding of the—at least in sections—oval measuring tube against each other in such a way that all in all the influence of the internal pressure on the stiffness of the measuring tube in the direction of the longer axis of the oval cross-section is at least attenuated or ideally compensated, preferably completely.

In order to render this compensation effect possible, it is thus crucial that the longer axis of the oval cross-section of the measuring tube is oriented essentially in the direction of the vibration of the measuring tube induced by the vibration exciter. It is only in this arrangement that the effects of the pressure increase and the rounding of the tube cross-section on the stiffness with respect to the vibration induced by the vibration exciter are in exact opposition and cancel each other out at least partially and preferably completely. In the context of the invention, “essentially” means that a certain deviation from the exact orientation of the longitudinal axis of the oval shape in the vibration direction is admissible. The vibration direction is basically the vibration direction induced in the measuring tube by the vibration exciter. Deviations of the longitudinal axis from the vibration direction of the measuring tube are possible as long as they do not influence the measurement results negatively beyond an acceptable tolerance limit. While this depends on the device type, the longitudinal axis of the oval shape will generally not deviate from the vibration direction of the measuring tube by more than 5°.

The invention thus differs from the conventional use of various tube geometries in Coriolis mass flow meters in that the specific oval shape of the measuring tube oriented essentially in the vibration direction provides the reduction in accordance with the invention of the pressure dependence of the measurement performed by the Coriolis mass flow meter. The invention thus goes beyond a mere adjustment of the measuring tube for the setting of a desired stiffness and renders possible a measurement that is to a certain extent pressure-independent, which cannot be achieved with conventional Coriolis mass flow meters.

There are Coriolis mass flow meters with only one measuring tube. Other known types include two or more measuring tubes. According to a preferred embodiment of the invention, two, in particular U-shaped, measuring tubes are arranged between the inlet and the outlet, wherein the two measuring tubes are connected by means of a fixing element in the region of the inlet and/or the outlet in such a manner that their position relative to each other is fixed. The fixing element can be configured, for example, as a gusset plate. According to the preferred embodiment, both measuring tubes respectively comprise at least one section with an oval cross-section. Overall, it is generally preferable that all the measuring tubes of the Coriolis mass flow meter comprise at least one section with an oval cross-section, regardless of how many measuring tubes are used. This way, the measurement at all measurement tubes is more pressure-independent than is the case with comparable circular tubes.

Generally, every oval tube shape, i.e. any tube with an oval cross-section at least in sections of the same, will lead to the rounding described, while different shapes lead to different changes in stiffness in the direction of the longer axis of the cross-section. The exact configuration of the cross-section can therefore be adapted to the concrete application so that under the prevailing conditions during operation—starting from an oval cross-section—a rounder cross-section results and the increase in stiffness in the case of an increased internal pressure is compensated. An exactly circular cross-section, at which the compensation capability of the oval section would theoretically end, is not reached under the pressures typically occurring in practice. An elliptical shape of the cross-section of the measuring tube in the oval section is particularly suitable for the present invention and thus preferred. The cross-section thus has the shape of an ellipse. The longer axis of the oval cross-section is in this case the major axis of the ellipse, while the shorter axis is the minor axis. Oval cross-sections in the sense of the invention also comprise shapes that also include straight sections in addition to rounded ones. According to another preferred embodiment, the cross-section of the measuring tube in the oval section comprises two round sections and two flat sections, which respectively lie across from one another. The straight or flat sections of the cross-section are oriented parallel to the longer axis and thus also parallel to the vibration direction.

A further effect of the use of oval tubes which needs to be considered in accordance with the invention is, e.g., a volume change of the tube in the oval section when rounding. This can influence the accuracy of the measurement of the Coriolis mass flow meter, in particular the density measurement. Moreover, the influences of the decrease in ovality on the phase angle and on the resonance frequency also differ. A further parameter is the length of the oval section along the direction of flow of the fluid. This length can also be adjusted and optimized in accordance with the concrete application. This means that a different ovality and/or a different length of the oval section in the direction of flow can be advantageous depending on the intended application. For example, the ovality and the length can be selected in such a manner that the influence of the pressure on the measurement of the mass flow becomes minimal, e.g. zero. Alternatively, the ovality and the length can be selected in such a manner that the influence of the pressure on the measurement of the density becomes minimal, e.g. zero. A corresponding solution can thus be selected for applications in which a particularly accurate measurement of either the mass flow or the density of the fluid is crucial. It is now particularly preferred that, with respect to their ovality and the length of the oval section in the direction of flow of the fluid as well as the cross-sectional shape, the at least one measuring tube and in particular all measuring tubes are configured in such a manner that the influence of the pressure on both the measurement of the mass flow and the measurement of the density of the fluid becomes minimal. The fact that the influence of the pressure on the conducted measurement does not disappear completely is considered acceptable here. However, the influence of the pressure can simultaneously be sufficiently reduced for both measurements that acceptable results are achieved. Thus, a compromise is reached between a complete compensation of the influence on the measurement of the mass flow and the influence on the measurement of the density. In this manner, with the Coriolis mass flow meter according to the invention, both the mass flow and the density can be determined in an improved manner compared to conventional devices. According to particularly preferred embodiments of the invention, the measurement tube is thus configured in such a manner that the ratio of the longer axis to the shorter axis of the measuring tube, i.e. the ovality, is smaller than 1.17 and larger than 1.01, preferably smaller than 1.15 and larger than 1.02, particularly preferably smaller than 1.1 and larger than 1.04, and especially smaller than 1.08 and larger than 1.05. In these ranges, a particularly fitting compromise can be achieved for an improved accuracy of the measurement of the mass flow and of the measurement of the density.

As already mentioned above, the longer axis of the oval cross-section of the measuring tube is oriented essentially in the direction of vibration. The best possible results are achieved if the longer axis of the oval cross-section of the measuring tube is oriented exactly in the direction of vibration. However, this can only be accomplished up to a certain degree of accuracy. Beyond this degree, the deviations caused by small inaccuracies are tolerable. However, it still applies that the more accurately the longer axis of the oval cross-section is oriented in the vibration direction, the better the invention works. It is thus preferred that an angle between the vibration direction and the longer axis of the oval cross-section of the measuring tube is at most 50, preferably at most 40, particularly preferably at most 3° and especially at most 20 or at most 10.

During the vibration movement of the measuring tube induced by the vibration exciter, different regions or sections of the measuring tube are bent to different extents. In particular in those regions in which the measuring tube is bent to a large extent, the change in stiffness of the measuring tube has a large influence on the conducted measurement. In particular those regions of the measuring tubes in which no or only very small Coriolis forces act on the fluid are typically deformed to a large extent. It is thus preferred to arrange the at least one section of the measuring tube with an oval cross-section at a point in the measuring tube where no or only very small Coriolis forces act on the fluid. In other words, it is thus preferred that the at least one section of the measuring tube with an oval cross-section is arranged in at least one area of the measuring tube in which an angle between the flow direction and the flow axis is particularly small, in particular minimal. The flow axis is parallel to the angular velocity of the vibration induced by the vibration exciter so that the Coriolis force acting on the fluid flowing in the measuring tube is particularly small in the aforementioned regions. Accordingly, the influence of a change in stiffness of the tube is particularly strong in these regions. Thus, the preferred regions are those measuring tube sections in which the measuring tube leads the fluid away from the flow axis and back into the same, and the measuring tube section which is farthest away from the flow axis and in which the flow direction of the fluid is deflected from away from the flow axis to back towards the flow axis. In other words, based on the example of a U-shaped measuring tube, the preferred regions lie at the ends of the branches and at the central curved segment.

The at least one measuring tube of the Coriolis mass flow meter is typically provided with a fixing element in both the region of the inlet and the region of the outlet, in particular if two measuring tubes are implemented. Therefore, according to a preferred embodiment, the at least one section of the measuring tube with an oval cross-section is located between these two fixing elements, particularly preferably also in the region of the inlet and/or the outlet, e.g. in the direction of flow of the fluid immediately behind the fixing element of the inlet and/or immediately in front of the fixing element of the outlet. Moreover, the entire length of the measuring tube between the fixing elements can be configured as a section with an oval cross-section. According to this variant, the measuring tube then has an oval shape between a fixing element arranged in the region of the inlet and a fixing element arranged in the region of the outlet.

The measuring tube is connected to a supply line via the inlet and to a discharge line for the fluid via the outlet. The entire length of the measuring tube thus extends from the inlet to the outlet. According to a further preferred embodiment, the measuring tube has an oval shape over its entire length. In this manner, the influence of the stiffening due to the ovality of the tube and also the decrease in stiffness due to the rounding of the tube in case of an increasing internal pressure prevail over the entire length of the measuring tube.

The object stated earlier is also achieved by a method for manufacturing a Coriolis mass flow meter with low pressure dependence, in particular a Coriolis mass flow meter as described above, in which at least one measuring tube is configured to allow a fluid medium to flow through it in a flow direction and is made to vibrate by a vibration exciter, comprising the steps: Providing a measuring tube with at least one oval section in which the measuring tube comprises, perpendicular to the flow direction, a longer axis and a shorter axis, and arranging the measuring tube in the Coriolis mass flow meter in such a manner that the longer axis of the oval section of the measuring tube is oriented essentially in the vibration direction and is configured in such a manner that the oval section of the measuring tube is rounded by the internal pressure prevailing during operation and the stiffness in the vibration direction decreases.

All features, effects and advantages described in relation to the Coriolis mass flow meter according to the invention also apply mutatis mutandis to the method according to the invention, and vice versa. In order to avoid repetition, reference is thus made to the description of the Coriolis mass flow meter also with respect to the method.

For example, it is also preferred with respect to the method that the length of the oval section of the measuring tube and its ovality are coordinated in such a manner that the dependence of the mass flow measurement and/or the dependence of the density measurement on the pressure of the fluid medium are reduced. In particular, it is preferred that the length of the oval section of the measuring tube and its ovality are coordinated in such a manner that an optimal reduction of the dependence of both the mass flow measurement and the density measurement on the pressure of the fluid medium is achieved. It is also preferred that a measuring tube is provided in which the ratio of the longer axis to the shorter axis is smaller than 1.17 and larger than 1.01, preferably smaller than 1.15 and larger than 1.02, particularly preferably smaller than 1.1 and larger than 1.04, and especially smaller than 1.08 and larger than 1.05.

As already mentioned, the exact configuration of the measuring tubes, in particular their length, their cross-sectional shapes and their ovality, can be designed differently depending on the concrete application. Differences can exist here, for example, with respect to the size and the material of the tubes used as well as their extension between the inlet and the outlet. It is generally preferred that the required length of the oval section of the measuring tube, its ovality and/or its cross-sectional shape are determined by means of the finite element method (FEM). Using FEM, the various parameters of the specific application can be optimized vis-à-vis one another numerically with the help of a computer. The details of the method are known to the person skilled in the art so that a detailed description of the same here is not necessary. In this manner, the optimal tube geometry with respect to stiffness and rounding under pressure can be determined in advance and an optimal design of the Coriolis mass flow meter can be achieved.

### BRIEF DESCRIPTION OF THE DRAWINGS

The invention is explained in greater detail below with the help of the examples shown in the figures, which show schematically:

FIG. 1 is a side view of a Coriolis mass flow meter;

FIG. 2 is the measuring tube inside the housing of the Coriolis mass flow meter according to FIG. 1;

FIG. 3 is the arrangement of two measuring tubes inside the housing of a Coriolis mass flow meter;

FIG. 4 is a side view of the extension of a measuring tube;

FIG. 5 is a circular cross-section of a measuring tube;

FIG. 6 is an oval cross-section of a measuring tube;

FIG. 7 is a cross-section of a measuring tube with two round sections and two flat sections respectively lying across from one another;

FIG. 8 is a flow chart of the method and

FIG. 9 is the correlation between pressure dependence of the density measurement and the ovality of the measuring tube in the region of a branch.

### DETAILED DESCRIPTION

Identical parts or parts acting in an identical manner are designated by identical reference numbers. Recurring parts are not designated separately in each figure.

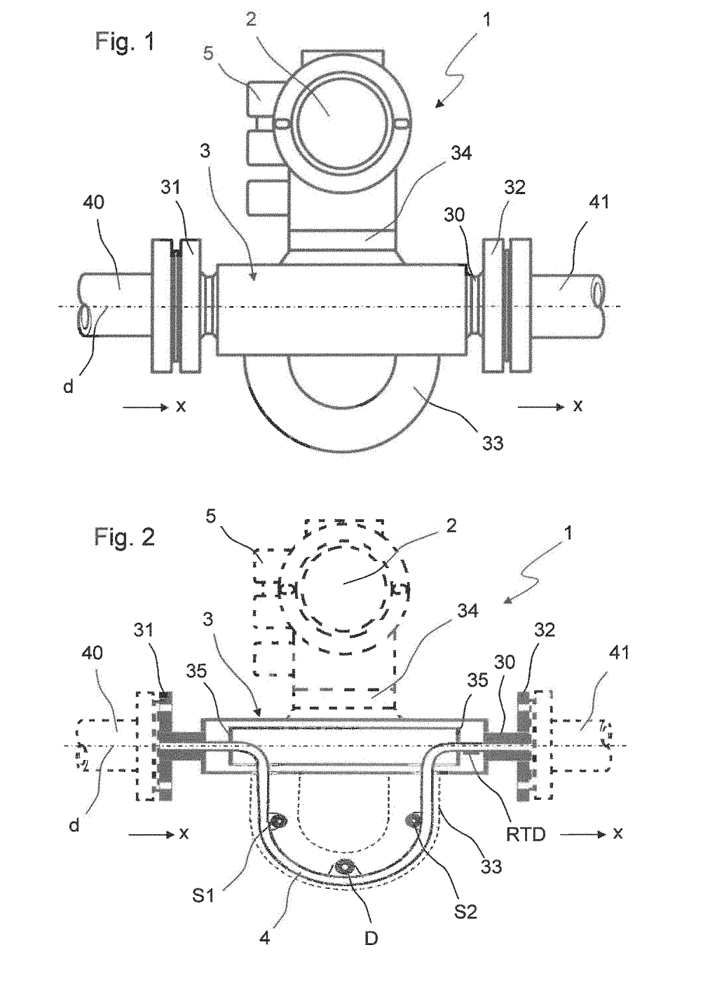

FIG. 1 shows a Coriolis mass flow meter 1 with a transmitter 2 and a housing 3. The transmitter 2 of the Coriolis mass flow meter 1 accommodates the electronics for, among other things, the vibration exciter and the vibration sensors, as well as a control unit 5. It is connected to the housing 3 via a collar 34. During operation, the Coriolis mass flow meter 1 with its housing 3 is fitted into a pipeline transporting the fluid to be measured. The Coriolis mass flow meter 1 especially comprises a connecting piece 30, which in turn comprises an inlet 31 for connection to a supply line 40 and an outlet 32 for connection to a discharge line 41 of the pipeline. The pipeline into which the Coriolis mass flow meter 1 is fitted defines the flow axis d. The flow axis d designates the direction in which the fluid would flow in the pipeline if it was not led through the Coriolis mass flow meter 1.

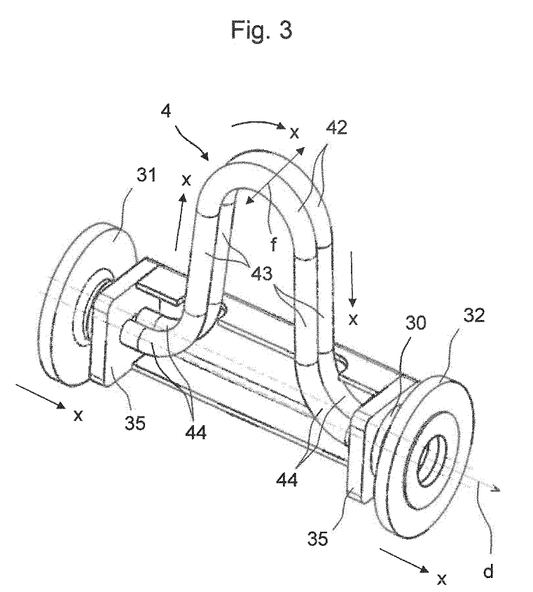

Moreover, the Coriolis mass flow meter 1 comprises a tube housing 33, in which the at least one measuring tube 4 is accommodated, as depicted in FIG. 2. FIG. 2 also shows the extension of the measuring tube 4 through the housing 3 from the inlet 31 via the tube housing 33 to the outlet 32. The extension of the measuring tube 4, which is U-shaped in the example shown, also defines the flow direction x of the fluid inside the measuring tube 4 and thus inside the Coriolis mass flow meter 1. The measuring tube 4 is respectively fixed in both the area of the inlet 31 and the area of the outlet 32 by a fixing element 35, which is configured as a gusset plate in the present example. These fixing elements 35 are all the more important in cases in which more than one measuring tube 4, e.g. two measuring tubes 4 (see, e.g., FIG. 3), are used. As is evident from FIG. 2, arranged on the measuring tube 4 is a vibration exciter D, which is implemented to cause the vibration, in particular resonant vibration, of the measuring tube 4 during the operation of the Coriolis mass flow meter 1. In FIG. 2, the vibrations excited by the vibration exciter D are respectively directed into and out of the paper plane. A first vibration sensor S1 and a second vibration sensor S2 are arranged on the measuring tube 4 in the flow direction x upstream and downstream of the vibration exciter D. The vibration sensors S1, S2 detect the movements of the measuring tube 4 and in particular the vibration induced by the vibration exciter D. Moreover, arranged on the measuring tube 4 is a temperature sensor RTD, which is, e.g., configured as a resistance thermometer.

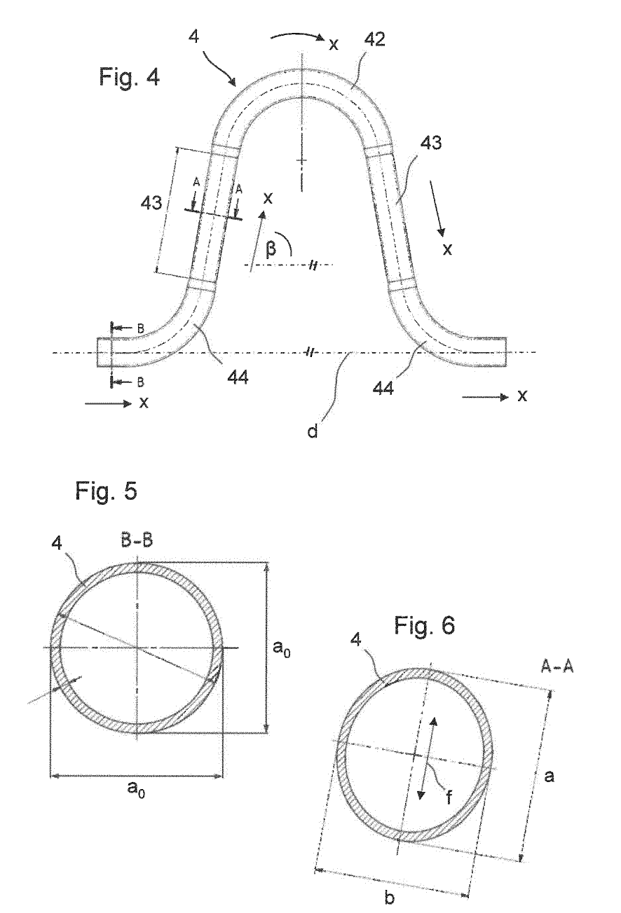

FIG. 3 illustrates the spatial arrangement of two parallel measuring tubes 4. FIG. 4 shows the geometry of such a measuring tube 4. Both measuring tubes 4 are respectively connected to the inlet 31 and the outlet 32. In these regions, they are respectively attached to each other via a fixing element 35, configured here as a gusset plate, so that their position relative to each other is fixed. In the example shown, the measuring tubes 4 have an essentially U-shaped extension, which also corresponds to the flow direction x of the fluid flowing through the measuring tubes 4. Each of the measuring tubes 4 comprises in particular two curves 44, two branches 43 and a curve segment 42 connecting the branches 43. The curves 44 here designate those sections of the measuring tubes 4 in which the fluid is respectively led into and out of the U-shaped protrusion. In the curves 44 and the curve segment 42, the flow direction x deviates from the flow axis d to an extent that is particularly small and especially minimal. The branches 43 designate those sections of the measuring tubes 4 in which the flow direction x deviates from the flow axis d to an extent that is particularly large and especially maximal. The curve segment 42 in turn describes the arcuate connection of the U-shaped protrusion between the two branches 43. The vibration direction f is also indicated in FIG. 3. The vibration direction f results from the vector of the angular velocity of the vibration induced by the vibration exciter D being parallel to the flow axis d and lying on the same. In the branches 43 of the measuring tubes 4, the flow direction x deviates from the flow axis d to the greatest extent. This is shown by the angle 3 between the flow direction x and the flow axis d (i.e. a line running parallel to the flow axis d) in FIG. 4. In the example shown, the angle 3 is particularly large in particular in the branches 43. In the curves 44 and the curve segment 42, by contrast, the angle 3 is particularly small. For this reason, the Coriolis forces acting on the fluid led through the measuring tube 4 are weakest in the area of the curves 44 and the curve segment 44. The sections of the measuring tubes 4 with an oval cross-section in accordance with the invention are thus preferably located in the region of the curves 44 and/or the curve segment 42. For example, a section with an oval cross-section can be provided only in a curve 44 or in the curve segment 42 of each measuring tube 4. However, it is preferred that at least one section with an oval cross-section is provided in each curve 44 and, particularly preferably, also in the curve segment 42. In the example shown, the measuring tubes 4 have an oval cross-sectional shape along the entire length of their curve 44, in particular in both curves 44, and in the curve segment 42. Over the length of the branches 43, by contrast, the measuring tubes 4 of the example shown have a circular cross-sectional shape.

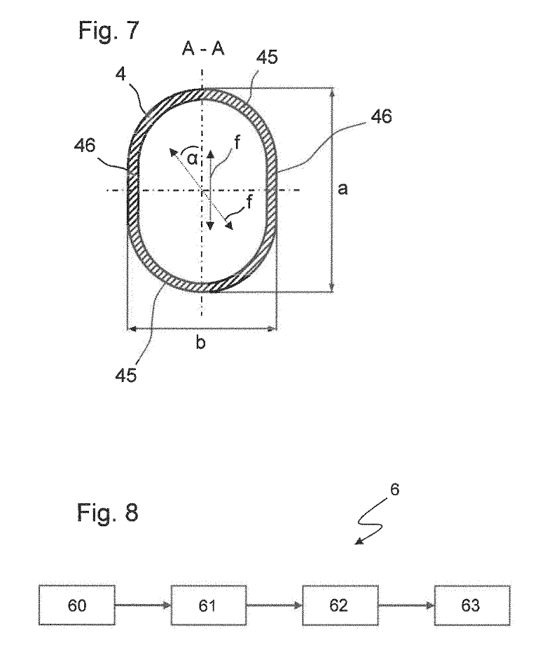

FIGS. 5, 6 and 7 respectively show different cross-sectional shapes of the measuring tubes 4. FIG. 5 shows a circular cross-section as present, for example, in the branches 43 of the measuring tube 4 according to FIGS. 3 and 4. Specifically, FIG. 5 shows the cross-section along line A-A of FIG. 4. The diameter of the tube in the sections with a circular cross-section is thus equal in all directions and is designated by a₀ in FIG. 5. By contrast, FIGS. 6 and 7 show oval cross-sectional shapes of the measuring tubes 4. For example, FIG. 6 shows a measuring tube 4 with an elliptical cross-section. The cross-section thus has unequal diameters, wherein the maximum diameter corresponds to the longer major axis a of the ellipse, while the minimum diameter corresponds to the shorter minor axis b of the ellipse.

FIG. 7 shows an alternative oval cross-section of a measuring tube 4. The cross-section according to FIG. 7 includes two round sections 45 and two flat sections 46, respectively lying across from one another. Round and flat here refers to the respective configuration of the tube wall. In the region of the round sections 45, the tube wall is rounded, in particular with a curvature corresponding to a circular tube as shown, e.g., in FIG. 5. In the region of the flat sections 46, by contrast, the tube wall is flat, i.e. planar. The ovality of the measuring tube 4 according to FIG. 7 is created by the combination of flat sections 46 and round sections 45. Accordingly, the cross-section through the measuring tube 4 according to FIG. 7 also comprises a longer axis a and a shorter axis b corresponding to the respective maximum and minimum tube diameters in the cross-section.

As indicated by line B-B in FIG. 4, sections with an oval cross-section according to FIG. 6 or FIG. 7 are arranged, for example, in the curves 44 and the curve segment 42 of the measuring tube 4. In this regard, they may be arranged either in only one curve 44 or the curve segment 42, or in both curves 44, or in both curves 44 and the curve segment 42 of the measuring tube 4. The length of the respective sections with an oval cross-section can also be adapted to the specific application. As also indicated in FIGS. 6 and 7, the measuring tubes 4 are arranged in such a manner that the longer axis a is oriented in the vibration direction f, i.e. parallel to the vibration direction f. The vibration direction f, which is indicated by the dashed line in FIG. 7, merely serves to illustrate the angle α between the vibration direction f and the longer axis a. The angle α, the size of which is exaggerated in FIG. 7 for the purpose of illustration, should be as small as possible. This way, the reduction of the stiffness of the measuring tube 4 in the vibration direction f due to a rounding of the tube has the greatest impact. The sections of the measuring tubes 4 with an oval cross-section can be introduced into tubes originally comprising a circular cross-section, e.g., through mechanical methods. For example, the sections with an oval cross-section can be introduced by pressing and/or by hydroforming. Additionally or alternatively, roll forming or other mechanical processes are also possible.

FIG. 8 shows a flow chart of the method 6. The method 6 starts at step 60 with the determination of the required length of the oval section of the measuring tube 4, its ovality (i.e. the ratio of the longer axis a to the shorter axis b) and/or its cross-sectional shape by means of the finite element method (FEM). With this numerical method, the design of the measuring tube 4 can be adapted to the working conditions of the specific application at hand so that the required tube geometry is known in advance. Step 61 typically takes place simultaneously with the determination of the tube geometry in step 60 or is included therein. In step 61, the parameters of the length of the oval section of the measuring tube, its ovality and its cross-sectional shapes are coordinated in such a manner that the dependence of the measurement of the Coriolis mass flow meter 1 on the pressure of the fluid medium is reduced. The measurement can relate to the measurement of the mass flow and/or the measurement of the density of the fluid medium. Should either the mass flow measurement or the density measurement be particularly important for the current application, the measuring tube 4 can be configured in such a manner that the dependence of the respective measurement on the pressure essentially disappears. If both measurements are important, it is at least possible to reach a compromise in the design of the measuring tube 4, according to which an optimal reduction of the dependence of both the mass flow measurement and the density measurement on the pressure of the fluid medium is achieved. Although the pressure dependence of the respective measurements will not disappear completely in this case, it can be reduced simultaneously for both measurements. The measuring tube 4 determined in this manner is then provided in step 62 of the method 6. The measuring tube 4 thus comprises at least one oval section in which the measuring tube 4 comprises, perpendicular to the flow direction x, a longer axis a and a shorter axis b. In step 63 of the method 6, the measuring tube 4 is then arranged inside the Coriolis mass flow meter 1 in such a manner that the longer axis a of the oval section of the measuring tube 4 is oriented essentially in the vibration direction f. As a result of the tube geometry of the measuring tube 4 described above, the measuring tube 4 is configured so that its oval section is rounded by the internal pressure prevailing during the operation of the Coriolis mass flow meter 1 and the stiffness in the vibration direction f decreases. This effect counteracts the stiffening of the measuring tube 4 caused by the increased internal pressure so that these two influences at least partially cancel each other out. In this manner, the pressure dependence of the measurement overall can be reduced with the Coriolis mass flow meter 1 manufactured with the method 6 according to the invention.

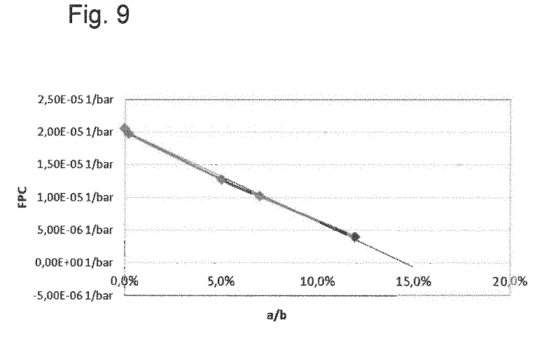

FIG. 9 shows illustratively the results of a calculation using FEM. In the diagram shown in FIG. 9, the ovality of the section of the measuring tube 4 with an oval cross-section is plotted on the abscissa as a quotient of the longer axis a and the shorter axis b. The ordinate shows the pressure dependence of the resonance frequency of the measuring tube 4. Specifically, the FPC value plotted on the ordinate is calculated from the derivative of the resonance frequency in accordance with the pressure, divided by the resonance frequency at 20° C. Since, as explained above, the density of the fluid medium is calculated from the resonance frequency, FIG. 9 shows the overall dependence of the density measurement on the pressure of the fluid medium for different ovalities of the measuring tube 4. The object of the invention is thus to minimize this pressure dependence, i.e. the value of FPC, as far as possible. The diamonds in the diagram respectively show values of FPC, which are calculated using FEM, at the corresponding ovality. As is evident from this figure, the calculated values result in a more or less straight line, which has been extrapolated to an FPC value of zero by means of the thin line. Accordingly, the measurement of the density of the fluid medium would become completely independent of the pressure approximately at an ovality of the measuring tube 4 of 15%, i.e. the rounding of the measuring tube 4 would lead to a complete compensation of the increase in stiffness of the measuring tube 4 caused by the rise in pressure. An analogous calculation can also be performed for the pressure dependence of the measurement of the mass flow. The results of the calculation using FEM described above were based on a model in which the section of the measuring tube 4 with an oval cross-section was located in one of the branches 43. This was for the purely practical reason that the calculation using FEM is easier to perform in this case. As already described above, however, the effects of the section with an oval cross-section are greater if the latter is arranged, for example, in the curves 44 and/or in the curve segment 43 of the measuring tube 4. Therefore, it must be expected in these cases that the respective influence of the ovality on the pressure dependence of the density measurement and the mass flow measurement is even greater.

What is claimed is:

1. A Coriolis mass flow meter, comprising:
a housing with an inlet and an outlet for a fluid medium, which are arranged along a flow axis (d);
at least one measuring tube configured to allow the fluid medium to flow through it in a flow direction (x) and arranged between the inlet and the outlet, wherein the measuring tube comprises at least one section with an oval cross-section such that the oval cross-section of the measuring tube comprises, perpendicular to the flow direction (x), a longer axis (a) and a shorter axis (b);
a vibration exciter (D) configured to cause the measuring tube to vibrate in a vibration direction (f); and
two vibration sensors for detection of the movements of the measuring tube, wherein the longer axis (a) of the oval cross-section of the measuring tube is oriented along the vibration direction (f).

2. The Coriolis mass flow meter according to claim 1, wherein:
the at least one measuring tube arranged between the inlet and the outlet comprises two measuring tubes, arranged between the inlet and the outlet, the two measuring tubes each being U-shaped,
wherein the two measuring tubes are connected to a fixing element in a region of the inlet and/or the outlet such that a position of the two measuring tubes relative to each other is fixed, and
wherein the two measuring tubes each comprise at least one section with an oval cross-section.

3. The Coriolis mass flow meter according to claim 1, wherein:
the oval cross-section of the measuring tube in is elliptical.

4. The Coriolis mass flow meter according to claim 1, wherein:
The oval cross-section of the measuring tube comprises two curved wall sections and two straight wall sections, respectively lying across from one another.

5. The Coriolis mass flow meter according to claim 1, wherein:
the measurement tube has a ratio of the longer axis (a) to the shorter axis (b) of less than 1.17 and greater than 1.01.

6. The Coriolis mass flow meter according to claim 1, wherein:
an angle (α) between the vibration direction (f) and the longer axis (a) of the oval cross-section of the measuring tube is at most five degrees.

7. The Coriolis mass flow meter according to claim 1, wherein:
the at least one section of the measuring tube with the oval cross-section is arranged in at least one area of the measuring tube in which an angle (β) between the flow direction (x) and the flow axis (d) exists.

8. The Coriolis mass flow meter according to claim 1, wherein:
the measuring tube has an oval shape between a fixing element arranged in an area of the inlet and a fixing element arranged in an area of the outlet.

9. The Coriolis mass flow meter according to claim 1, wherein:
the measuring tube has an oval shape over an entire length.

10. A method for manufacturing a Coriolis mass flow meter having at least one measuring tube configured to allow a fluid medium to flow through the measuring tube in a flow direction (x) and is caused to vibrate by a vibration exciter (D), comprising:
providing a measuring tube with at least one oval section in which the measuring tube comprises, perpendicular to the flow direction (x), a longer axis (a) and a shorter axis (b); and
arranging the measuring tube in the Coriolis mass flow meter such that the longer axis (a) of the oval section of the measuring tube is oriented along a vibration direction (f) and is configured such manner that the oval section of the measuring tube is rounded by internal pressure prevailing during operation and stiffness in the vibration direction (f) decreases.

11. The method according to claim 10, wherein:
a length of the oval section of the measuring tube and a ratio of the longer axis (a) to the shorter axis (b) of the measuring tuber are coordinated such that a dependence of a mass flow measurement and/or a dependence of a density measurement on a pressure of the fluid medium are reduced.

12. The method according to claim 10, wherein:
a length of the oval section of the measuring tube and a ratio of the longer axis (a) to the shorter axis (b) of the measuring tube are coordinated in such a manner that an optimal reduction of the dependence of both a mass flow measurement and a density measurement on a pressure of the fluid medium is achieved.

13. The method according to claim 10, wherein:
the measuring tube has a ratio of the longer axis (a) to the shorter axis (b) of less than 1.17 and greater than 1.01.

14. The method according to claim 10, wherein:
using finite element analysis to determine at least one of a length of the oval section of the measuring tube, a ratio of the longer axis (a) to the shorter axis (b) of the measuring tube a cross-sectional shape of the oval section of the measuring tube.

15. The Coriolis mass flow meter according to claim 5, wherein:
the ratio of the longer axis (a) to the shorter axis (b) is less than 1.15 and greater than 1.02.

16. The Coriolis mass flow meter according to claim 15, wherein:
the ratio of the longer axis (a) to the shorter axis (b) is less than 1.1 and greater than 1.04.

17. The Coriolis mass flow meter according to claim 16, wherein:
the ratio of the longer axis (a) to the shorter axis (b) is less than 1.08 and greater than 1.05.

18. The Coriolis mass flow meter according to claim 6, wherein:
the angle (α) between the vibration direction (f) and the longer axis (a) of the oval cross-section of the measuring tube is at most four degrees.

19. The Coriolis mass flow meter according to claim 18, wherein:
the angle (α) between the vibration direction (f) and the longer axis (a) of the oval cross-section of the measuring tube is at most three degrees.

20. The Coriolis mass flow meter according to claim 19, wherein:
the angle (α) between the vibration direction (f) and the longer axis (a) of the oval cross-section of the measuring tube is at most two degrees.
